(19) United States
(12) Patent Application Publication
(10) Pub. No.: US 2016/0270414 A1
(43) Pub. Date: Sep. 22, 2016

(54) COOKING OILS WITH HERBAL AROMA

(71) Applicant: INTERNATIONAL FOODSTUFFS CO. LLC, Sharjah (AE)

(72) Inventors: Sergio Carlos De Sousa, Dubai (AE); Mayamol Nichlavose, Sharjah (AE)

(21) Appl. No.: 14/658,547

(22) Filed: Mar. 16, 2015

(51) Int. Cl. A23D 9/007

(52) U.S. Cl. CPC A23D 9/007

(57) ABSTRACT

The present disclosure relates to the production of cooking oils which infuses a refreshing and pleasant aroma in the kitchen while cooking and frying without affecting the natural taste and smell of the food. The present disclosure provides a cooking oil with herbal aroma which includes 99.27%-99.99% of edible oil and 0.01%-0.8% of herbal flavoring ingredients.

### FIELD OF INVENTION

The present disclosure relates to oils with herbal aroma when heated substantially reduces unpleasant smell.

### BACKGROUND OF THE INVENTION

Frying is the cooking of food in fat. This takes several forms, from deep frying where the food is completely immersed in hot oil, to sautéing where food is cooked in a frying pan where there is only a thin coating oil. Frying is the fastest way to cook, as it is the most efficient way to transfer heat into the food. The unsaturated fatty acids present in the oils are more prone to oxidation during frying and break down to form undesirable flavor compounds such as free fatty acids, polymers, oxidized triglycerides, aldehydes, ketones by hydrolysis, oxidation and polymerization. These flavor compounds changes the flavor of the oil and releases an unpleasant odor.

Normally unpleasant smell of cooking oil is present when oil is heated before cooking and stench evolves more with the increase in the temperature. This can be avoided if spice flavors like garlic, pepper, onion can be used, however these spice flavors will affect the taste and smell of the cooked food.

In U.S. patent WO 1996028980 by Christopher Randall Beharry et al invented flavored cooking oil having reduced room aroma, with polysorbate 80 a food emulsifier as aroma suppressor. The impact of flavor on the taste and smell of food is not mentioned in his study.

The main objective of the present invention is to produce cooking oil with herbal aroma which infuses a refreshing and pleasant smell in the kitchen while cooking and frying and also have no impact on the taste and smell of the cooked or fried food.

### SUMMARY OF THE INVENTION

The present invention relates to the production of cooking oils with herbal aroma which significantly reduces the unpleasant flavour of oil upon heating. This oil comprises 99.2%-99.99% of edible oil and 0.01%-0.8% of herbal flavoring ingredients.

### DETAILED DESCRIPTION OF THE INVENTION

Cooking Oils

As used herein “cooking oils” are vegetable oils, triglycerides extracted from a plant. Such oils have been part of human culture for years. The term “vegetable oils” can be narrowly defined to plant oils that are liquid at room temperature. Molecules of vegetable oils consist of glycerol and fatty acids. Glycerol has three carbon atoms and fatty acids have long chains of carbon atoms. The long fatty acid chains stop vegetable oils dissolving in water. The fatty acids in some vegetable oils are saturated and only have single bonds between some of their carbon atoms. Saturated oils tend to be solid at room temperature and are sometimes called vegetable fats instead of oils. The fatty acids in some vegetable oils are unsaturated and have double bonds between some of their carbon atoms. Unsaturated oils tend to be liquid at room temperature and are useful for frying food.

Herbal Aroma

As used herein “Herbal Aroma” refers to a natural or synthetic flavoring aromatic plant origin. These plant sources derived from leaves, a dry plant seeds, bark or roots of plants.

The term “Herbal Aroma” used here in include flavoring components from basil and rosemary. The herbal aroma components are volatile, which are released upon heating. In embodiments, the herbal aroma component is oil soluble, and in liquid form to eliminate the difficulties in commercial production. In embodiments, the flavoring components are basil and rosemary.

The level of herbal aroma components is adjusted in such a way that it should impart a desired herbal aroma to the oil without affecting the taste and smell of the food. The amount of herbal aroma component added is in the range of 0.01% to 0.8%. The level is dependent upon many factors such as intensity of herbal aroma desired without affecting the natural taste and flavor of the food, type of herbal aroma component used, type of oil being flavored etc. In embodiments, a level of about 0.08% to about 0.6% of the herbal aroma component is used to impart a desirable flavor without affecting the natural taste and flavor of the food, in embodiments, from about 0.1 to 0.35% of the flavor component is used.

The following examples are given by way of illustration and therefore should not be constructed to limit the scope of the present invention.

### EXAMPLE 1

40 kg of Refined Bleached and Deodorized sunflower oil was taken in a mixing tank. The mixing tank is provided with agitator. 60 gm of basil aroma component was added to the oil at ambient temperature (23-26° C.) and mixed well for 30 minutes. After 30 minutes, basil flavored sunflower oil was packed in PET (Poly ethylene terephthalate) bottles. Frying trials of this flavored oil was conducted in a test kitchen. The food products fried were French fries and chicken fries. The aroma was tested by trained panelists. The outcome of the trials shows that during frying, the aroma of the oil was felt in the kitchen while smell and taste of the foods remain unchanged.

### EXAMPLE 2

40 kg of Refined Bleached and Deodorized corn oil was taken in a mixing tank. The mixing tank is provided with agitator. 80 gm of basil aroma component was added to the oil at ambient temperature (23-26° C.) and mixed well for 30 minutes. After 30 minutes, basil flavored corn oil was packed in PET (Poly ethylene terephthalate) bottles. Frying trials of this flavored oil was conducted in a test kitchen. The food products fried were French fries and chicken fries. The aroma was tested by trained panelists. The outcome of the trials shows that during frying, the aroma of the oil was felt in the kitchen while smell and taste of the foods remain unchanged.

### EXAMPLE 3

40 kg of Refined Bleached and Deodorized canola oil was taken in a mixing tank. The mixing tank is provided with agitator. 6.68 gm of rosemary aroma component was added to the oil at ambient temperature (23-26° C.) and mixed well for 30 minutes. After 30 minutes, rosemary flavored canola oil was packed in PET (Poly ethylene terephthalate) bottles. Frying trials of this flavored oil was conducted in a test kitchen. The food products fried were French fries and chicken fries. The aroma was tested by trained panelists. The outcome of the trials shows that during frying, the aroma of the oil was felt in the kitchen while smell and taste of the foods remain unchanged.

### EXAMPLE 4

40 kg of Refined Bleached and Deodorized soybean oil was taken in a mixing tank. The mixing tank is provided with agitator. 100 gm of basil aroma component was added to the oil at ambient temperature (23-26° C.) and mixed well for 30 minutes. After 30 minutes, basil flavored soybean oil was packed in PET (Poly ethylene terephthalate) bottles. Frying trials of this flavored oil was conducted in a test kitchen. The food products fried were French fries and chicken fries. The aroma was tested by trained panelists. The outcome of the trials shows that during frying, the aroma of the oil was felt in the kitchen while smell and taste of the foods remain unchanged.

The main advantages of the present invention:
1) Cooking oils with herbal aroma which infuses a refreshing and pleasant smell in the kitchen while cooking and frying.
2) Taste and smell of the cooked food remain unchanged.

1) A cooking oil with herbal aroma comprising 99.27%-99.99% of edible oil and 0.01%-0.8% of herbal flavoring ingredients.

2) The cooking oil with herbal aroma according to claim 1, wherein the edible oil is selected from sunflower oil, corn oil, soybean oil and canola oil.

3) The cooking oil with herbal aroma according to claim 1, wherein the edible oil is selected from unsaturated fatty acid rich oil.

4) The cooking oil with herbal aroma according to claim 1, wherein the herbal aroma components are selected from basil and rosemary.

5) The cooking oil with herbal aroma according to claim 1, wherein the level of herbal aroma component is from 0.01% to 0.8%

6) The cooking oil with herbal aroma according to claim 1, wherein the oil spreads a pleasant smell in the kitchen while cooking and frying without affecting the natural taste and smell of the food.
